(19) United States
(12) Patent Application Publication
(10) Pub. No.: US 2026/0299791 A1
(43) Pub. Date: Oct. 1, 2026

(54) INFORMATION PROCESSING APPARATUS, LIFE PREDICTION METHOD FOR INFORMATION PROCESSING APPARATUS, AND NON-TRANSITORY RECORDING MEDIUM

(71) Applicant: Kazuya Tani, Tokyo (JP)

(72) Inventor: Kazuya Tani, Tokyo (JP)

(73) Assignee: Ricoh Company, Ltd., Tokyo (JP)

(21) Appl. No.: 19/577,731

(22) Filed: Mar. 25, 2026

(30) Foreign Application Priority Data
Apr. 1, 2025 (JP) 2025-060433

(51) Int. Cl. G06F 3/06

(52) U.S. Cl. CPC G06F 3/0616; G06F 3/0653; G06F 3/0676

(57) ABSTRACT

An information processing apparatus includes: storage; and circuitry that periodically acquires information related to the storage from management information; periodically acquires user information stored in the storage; and inputs the information related to the storage and the user information to a trained model and output life prediction data of the information processing apparatus, the trained model being a model to predict a life of the information processing apparatus based on the management information and the user information.

### CROSS-REFERENCE TO RELATED APPLICATIONS

This patent application is based on and claims priority pursuant to 35 U.S.C. § 119(a) to Japanese Patent Application No. 2025-060433, filed on Apr. 1, 2025, in the Japan Patent Office, the entire disclosure of which is hereby incorporated by reference herein.

### BACKGROUND

### Technical Field

The present disclosure relates to an information processing apparatus, a life prediction method for the information processing apparatus, and a non-transitory recording medium.

### Related Art

An information processing apparatus such as an image forming apparatus is equipped with storage such as a solid-state drive (SSD). When the storage reaches the end of life based on the write count, the storage may no longer store user data, leading to the inability to use the information processing apparatus. Accordingly, a life prediction technique is to statistically determine the life of the storage by using Self-Monitoring, Analysis, and Reporting Technology (S.M.A.R.T. or SMART) information.

However, life prediction techniques of the related art have the following issues. Since the applications of information processing apparatuses are diverse, the number of writes in image forming processing may increase sharply depending on user usage, leading to the storage reaching the end of life, and an unexpected failure may occur. Consequently, prediction relying solely on S.M.A.R.T. information is risky, and accurate life prediction is difficult to achieve.

### SUMMARY

The present disclosure described herein provides an information processing apparatus including storage and circuitry. The circuitry periodically acquires information related to the storage from management information, periodically acquires user information stored in the storage, and inputs the information related to the storage and the user information to a trained model and outputs life prediction data of the information processing apparatus, the trained model being a model to predict a life of the information processing apparatus based on the management information and the user information.

The present disclosure described herein provides a life prediction method for an information processing apparatus. The life prediction method includes periodically acquiring information related to storage included in the information processing apparatus from management information; periodically acquiring user information stored in the storage; and inputting the information related to the storage and the user information to a trained model and outputting life prediction data of the information processing apparatus, the trained model being a model to predict a life of the information processing apparatus based on the management information and the user information.

The present disclosure described herein provides a non-transitory recording medium storing a plurality of instructions which, when executed by one or more processors, causes the one or more processors on an information processing apparatus to perform the above-described life prediction method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a configuration diagram illustrating an example of hardware of an image forming apparatus as an example of an information processing apparatus;

FIG. 2 is a diagram illustrating an example of a life prediction function;

FIG. 3 is a block diagram illustrating an example of functions of an image forming apparatus;

FIG. 4 is a flowchart illustrating an example of life prediction control when storage includes an SSD;

FIG. 5 is a flowchart illustrating an example of life prediction control when storage includes a hard disk drive (HDD);

FIG. 6 is a flowchart illustrating a first example of failure notification control of an image forming apparatus; and

FIG. 7 is a flowchart illustrating a second example of failure notification control of an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

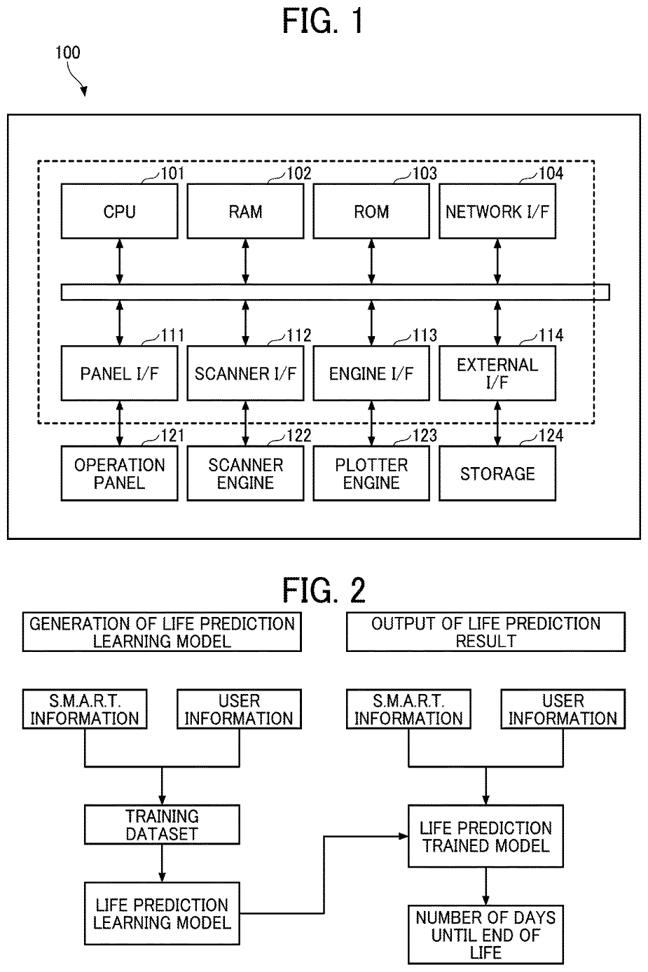

FIG. 1 is a hardware configuration diagram of an image forming apparatus 100 as an example of an information processing apparatus.

As illustrated in FIG. 1, the hardware of the image forming apparatus 100, which is an information processing apparatus, includes a central processing unit (CPU) 101, a random-access memory (RAM) 102, a read-only memory (ROM) 103, a network interface (I/F) 104, a panel I/F 111, a scanner I/F 112, an engine I/F 113, an external I/F 114, an operation panel 121, a scanner engine 122, a plotter engine 123, and a storage 124, and these components are connected to each other.

The image forming apparatus 100 includes the CPU 101, the RAM 102, and the ROM 103 to control the image forming apparatus 100. The ROM 103 stores a program (information processing program) and various data, and the program (information processing program) is executed to boot the image forming apparatus 100. The RAM 102 temporarily stores, for example, various programs read from the ROM 103, and print data.

The network I/F 104 is an interface for connecting the image forming apparatus 100 to a network.

The panel I/F 111 is an interface for operating the operation panel 121. The operation panel 121 has a display function for displaying a message to a user and keys for receiving an operation from the user.

The scanner I/F 112 is an interface for communicating with the scanner engine 122. The scanner engine 122 reads image data, and the read image data is written to the RAM 102 through the scanner I/F 112.

The engine I/F 113 is an interface for communicating with the plotter engine 123. The engine I/F 113 sends print data to the plotter engine 123, and accordingly the plotter engine 123 prints an image on paper.

The external I/F 114 is an interface for exchanging data with the storage 124. The storage 124 temporarily stores image data when a sort function is used, and stores image data using a document storage function.

The storage 124 includes, for example, a solid-state drive (SSD) or a hard disk drive (HDD).

The image forming apparatus 100 as an example of an information processing apparatus predicts the life of the image forming apparatus 100, and displays a notification on an operation unit of the image forming apparatus 100, such as the operation panel 121, when the life is predicted to be reaching the end. Further, the image forming apparatus 100 provides a notification when information related to a failure of the image forming apparatus 100 is acquired.

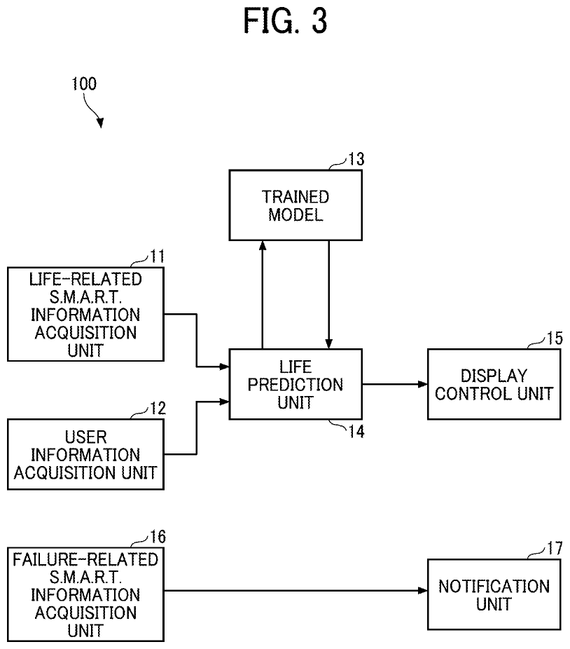

Among the functions of the image forming apparatus 100 described above, a life prediction function will be further described. FIG. 2 is a diagram illustrating the life prediction function. The life prediction function involves acquiring “S.M.A.R.T. information” and “user information” of devices on the market (e.g., the image forming apparatus 100), creating a learning model in advance, and inputting information on a device in use to a trained model 13 (see FIG. 3) to output life prediction data. As a result, a relationship between the user's usage patterns of the device and the actual percentage of device life used is learned, and an accurate prediction of the remaining life is obtained.

Examples of such a learning model for life prediction may include a multilayer neural network. A machine learning method, for example, deep learning or a backpropagation method, may be applied.

The S.M.A.R.T. information is an example of management information, which is information for predicting, for example, a life and a failure. The S.M.A.R.T. information refers to, for example, various types of information related to a health condition of the storage 124 and issued by the storage 124. The S.M.A.R.T. information includes, for example, the following types of information:
Total logical block addresses (LBAs) written (SSD);
Power-on time (HDD);
Operating time (HDD);
Head load/unload cycle count (HDD);
Head retract time (HDD);
Read error rate;
Reallocated sectors count; and
Seek error rate.

In the example described above, information used when the storage 124 includes an SSD and information used when the storage 124 includes an HDD are marked with “(SSD)” and “(HDD)”, respectively.

The S.M.A.R.T. information includes numerical values stored in the storage 124, such as an HDD or an SSD, and representing a state of the image forming apparatus 100. Originally, the S.M.A.R.T. information is provided for the purpose of failure diagnosis. Thus, it is possible to predict the life to some extent based on the S.M.A.R.T. information. However, an unexpected failure may occur, and diagnosis relying solely on the S.M.A.R.T. information can involve a risk.

Accordingly, in addition to the S.M.A.R.T. information, user information of a multifunction peripheral (MFP), which is an example of an information processing apparatus including the image forming apparatus 100, is used for a training dataset in order to provide more flexible life prediction tailored to the user.

The user information includes, for example, the following types of information:
Number of executions of a job;
Number of pages of a job;
Color/monochrome setting;
Presence or absence of overlaying or stamping;
Number of stored jobs; and
Address book update.

The user information refers to overall device usage logs and setting values stored in the MFP. Numerical values indicating a usage status of the user are extracted from the user information and used for the dataset. Information that can be used includes the following.

Number of executions of a job: The number of executions of a job is recorded for each of the basic functions such as copying, printing, scanning, and faxing. Even a normal printing process involves storing an image in a temporary area of the storage. Since write volumes to the storage differ by function, information on the number of times a job has been executed for each function is useful for estimating the write count of the storage.

Number of pages of a job: Information on a job includes information on the number of pages. One function involves writing a whole page to the storage in a single operation, while another function involves dividing a page into multiple segments and writing the segments to the storage individually. When the storage has a write count of 10, it is indistinguishable based on the S.M.A.R.T. information whether the count results from ten executions of a job or from ten write operations performed for a single page based on a function specification. The user information provides a more detailed user usage status.

Color/monochrome setting: In a color mode using four colors, namely, cyan, magenta, yellow, and key (black) (CMYK), storage access is performed for each of the four colors. In a monochrome mode, storage access is performed for only a single color. A simple calculation indicates that the storage access count for the color mode is four times that for the monochrome mode.

Presence or absence of overlaying or stamping: This value indicates whether image composition such as overlaying or stamping is applied to an executed job. In an MFP, data from which image composition is generated, such as text or a stamp, is generally stored in storage. Overlaying a document involves storage access to apply an overlay image.

Number of stored jobs: This value indicates the number of executions of jobs for document storage. An MFP is generally provided with a document storage function. Storing a document involves writing the data to the storage, and thus generates a larger number of storage access operations than normal printing does.

Address book update: An MFP is provided with an address book function for storing, for example, document distribution destinations. An update of the address book is recorded as a device log. Since address book data is stored in the storage, registering a new entry or editing the address book results in data being written to the storage, and thus the update frequency affects the life of the storage.

The above are representative examples of the user information. There are other functions using the storage 124, and settings related to such functions are likely to affect the write count of the storage 124. Data extracted from such user information is used as training data.

When the image forming apparatus 100 is an MFP, it is preferable to determine a weight based on an application type per job, such as copy, printer, scanner, or fax, among the user information, and to utilize data associated with functions as training datasets such that a higher weight is assigned to a training dataset for a function having a larger amount of access to the storage 124. Thus, an accurate life prediction model can be acquired because information having a stronger correlation with the life of the image forming apparatus 100 is allowed to exert a greater influence on the machine learning of the model.

FIG. 3 is a functional block diagram of the image forming apparatus 100. As illustrated in FIG. 3, the image forming apparatus 100 includes functions related to the life prediction and failure notification described above, namely, a life-related S.M.A.R.T. information acquisition unit 11 (first acquisition unit), a user information acquisition unit 12 (second acquisition unit), a trained model 13, a life prediction unit 14, a display control unit 15, a failure-related S.M.A.R.T. information acquisition unit 16, and a notification unit 17.

The life-related S.M.A.R.T. information acquisition unit 11 acquires S.M.A.R.T. information related to the life of the image forming apparatus 100. When the storage 124 includes an SSD, the life-related S.M.A.R.T. information acquisition unit 11 acquires the write count of the storage 124, which corresponds to the “total LBAs written” described above, from among the S.M.A.R.T. information as life-related S.M.A.R.T. information. When the storage 124 includes an HDD, the life-related S.M.A.R.T. information acquisition unit 11 acquires at least one of the power-on time, the operating time, the head load/unload cycle count, and the head retract time of the storage 124 from among the S.M.A.R.T. information as life-related S.M.A.R.T. information. The life-related S.M.A.R.T. information acquisition unit 11 outputs the acquired life-related S.M.A.R.T. information to the life prediction unit 14.

The user information acquisition unit 12 acquires user information stored in the storage 124. The type of user information to be acquired includes at least one of the types of information described above, namely, the number of executions of a job, the number of pages of a job, the color/monochrome setting, the presence or absence of overlaying or stamping, the number of stored jobs, and the address book update. The user information acquisition unit 12 outputs the acquired user information to the life prediction unit 14.

The trained model 13 is a model for predicting the life of the image forming apparatus 100 based on S.M.A.R.T. information and user information, as described with reference to FIG. 2. The S.M.A.R.T. information and the user information are used as input information to the trained model 13. The trained model 13 outputs the number of days until the end of life in response to the input information.

The life prediction unit 14 inputs life-related S.M.A.R.T. information and user information acquired periodically by the image forming apparatus 100, namely, the life-related S.M.A.R.T. information acquisition unit 11 and the user information acquisition unit 12, respectively, to the trained model 13. Further, the life prediction unit 14 acquires information on life prediction data (e.g., the number of days until the end of life) of the image forming apparatus 100. The information on the life prediction data is output from the trained model 13 in response to the input information. The life prediction unit 14 outputs the acquired information on the life prediction data to the display control unit 15.

When the storage 124 includes an SSD, the life prediction unit 14 also inputs information on the write count acquired from the S.M.A.R.T. information to the trained model 13 as input information. When the storage 124 includes an HDD, the life prediction unit 14 also inputs at least one of the power-on time, the operating time, the head load/unload cycle count, and the head retract time of the storage 124 acquired from the S.M.A.R.T. information to the trained model 13 as input information. In other words, the life prediction unit 14 also inputs information related to the HDD to the trained model 13 as input information.

The display control unit 15 calculates a replacement time of the storage 124, based on the life prediction data input from the life prediction unit 14, and displays a notification on the operation unit of the image forming apparatus 100 (e.g., the operation panel 121 illustrated in FIG. 1) when the calculated replacement time is approaching.

The failure-related S.M.A.R.T. information acquisition unit 16 acquires S.M.A.R.T. information related to a failure of the image forming apparatus 100. The failure-related S.M.A.R.T. information includes, for example, at least one of the read error rate, the reallocated sectors count, and the seek error rate from among the S.M.A.R.T. information described above. The failure-related S.M.A.R.T. information acquisition unit 16 outputs the acquired failure-related S.M.A.R.T. information to the notification unit 17.

When the failure-related S.M.A.R.T. information input from the failure-related S.M.A.R.T. information acquisition unit 16 changes at a frequency exceeding a predetermined value, the notification unit 17 outputs a warning message to the operation unit of the image forming apparatus 100 (e.g., the operation panel 121 illustrated in FIG. 1). Alternatively, in the same case, the notification unit 17 reports to the customer support of the image forming apparatus 100. The predetermined value is, for example, a value set in advance by an administrator.

Preferably, the frequency of data acquisition and training is set to at most once per day, and when the remaining life is short, the frequency of information acquisition (the frequency of data acquisition and training) is further reduced. The “frequency of data acquisition and training” includes, for example, the frequency at which life-related S.M.A.R.T. information is acquired by the life-related S.M.A.R.T. information acquisition unit 11, the frequency at which user information is acquired by the user information acquisition unit 12, the frequency at which the trained model 13 is retrained, and the frequency at which failure-related S.M.A.R.T. information is acquired by the failure-related S.M.A.R.T. information acquisition unit 16. Frequent data acquisition and training may affect the life of the image forming apparatus 100, including shortening the life. Accordingly, setting the frequency to, for example, at most once per day can reduce the impact of data acquisition and training on the life of the image forming apparatus 100. When the remaining life is short, further reduction in the frequency of information acquisition can further reduce the impact on the life.

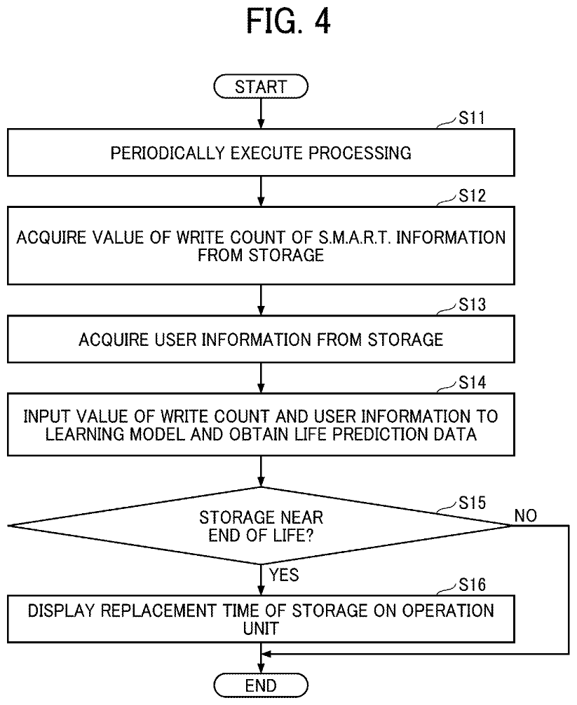

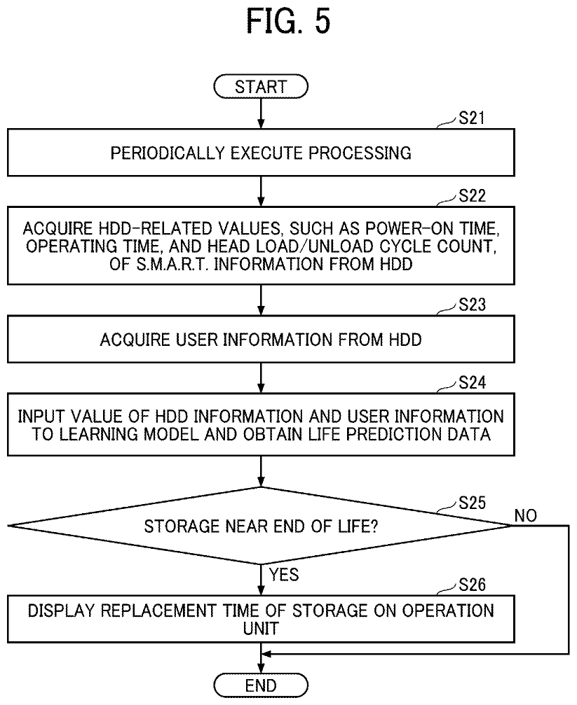

The life prediction function of the image forming apparatus 100 is described below with reference to FIG. 4 and FIG. 5.

FIG. 4 is a flowchart illustrating life prediction control when the storage 124 includes an SSD.

In step S11, control is performed such that the subsequent processing is executed periodically. As described above, “periodically” is preferably once per day, for example, and it is preferable to further reduce the frequency as the remaining life becomes shorter.

In step S12, the life-related S.M.A.R.T. information acquisition unit 11 acquires, from the SSD serving as the storage 124, a value of the write count from among the S.M.A.R.T. information.

In step S13, the user information acquisition unit 12 acquires user information from the SSD serving as the storage 124.

In step S14, the life prediction unit 14 inputs the value of the write count acquired in step S12 and the user information acquired in step S13 to the trained model 13, and obtains life prediction data of the image forming apparatus 100 based on output information of the trained model 13 corresponding to the input information.

In step S15, the display control unit 15 determines whether the SSD serving as the storage 124 is near the end of life, based on the life prediction data acquired in step S14. For example, the display control unit 15 holds, for example, in a local memory, a life threshold that is set to any predetermined number of days until a day when the image forming apparatus 100 reaches the end of life, and determines that the storage 124 is near the end of life when the life prediction data is less than or equal to the life threshold.

If it is determined in step S15 that the storage 124 is near the end of life (Yes in step S15), the process proceeds to step S16, and the display control unit 15 displays a replacement time of the storage 124 on the operation unit of the image forming apparatus 100 (e.g., the operation panel 121 illustrated in FIG. 1). When the processing of step S16 is completed, the control flow ends.

On the other hand, if it is determined in step S15 that the storage 124 is not near the end of life (No in step S15), the control flow ends without performing the processing of step S16.

FIG. 5 is a flowchart illustrating life prediction control when the storage 124 includes an HDD.

In step S21, control is performed such that the subsequent processing is executed periodically. As described above, “periodically” is preferably once per day, for example, and it is preferable to further reduce the frequency as the remaining life becomes shorter.

In step S22, the life-related S.M.A.R.T. information acquisition unit 11 acquires, from the HDD serving as the storage 124, values related to the HDD, such as the power-on time, the operating time, and the head load/unload cycle count, from among the S.M.A.R.T. information.

In step S23, the user information acquisition unit 12 acquires user information from the HDD serving as the storage 124.

In step S24, the life prediction unit 14 inputs the values of the information on the HDD acquired in step S22 and the user information acquired in step S23 to the trained model 13, and obtains life prediction data of the image forming apparatus 100 based on output information of the trained model 13 corresponding to the input information.

In step S25, the display control unit 15 determines whether the HDD serving as the storage 124 is near the end of life, based on the life prediction data acquired in step S24. For example, the display control unit 15 holds, for example, in a local memory, a life threshold that is set to any predetermined number of days until a day when the image forming apparatus 100 reaches the end of life, and determines that the storage 124 is near the end of life when the life prediction data is less than or equal to the life threshold.

If it is determined in step S25 that the storage 124 is near the end of life (Yes in step S25), the process proceeds to step S26, and the display control unit 15 displays a replacement time of the storage 124 on the operation unit of the image forming apparatus 100 (e.g., the operation panel 121 illustrated in FIG. 1). When the processing of step S26 is completed, the control flow ends.

On the other hand, if it is determined in step S25 that the storage 124 is not near the end of life (No in step S25), the control flow ends without performing the processing of step S26.

When the storage 124 of the image forming apparatus 100 includes both an SSD and an HDD, it is desirable to perform both the processes illustrated in the flowcharts of FIG. 4 and FIG. 5.

As described above, the image forming apparatus 100 as an example of an information processing apparatus including the storage 124 includes the life-related S.M.A.R.T. information acquisition unit 11 that acquires S.M.A.R.T. information related to the life of the image forming apparatus 100, the user information acquisition unit 12 that acquires user information stored in the storage 124, the trained model 13 that predicts the life of the image forming apparatus 100 based on the S.M.A.R.T. information and the user information, and the life prediction unit 14 that inputs the S.M.A.R.T. information and the user information, which are acquired periodically, to the trained model 13, and outputs life prediction data of the image forming apparatus 100. Preferably, the image forming apparatus 100 further includes the display control unit 15 that displays a notification on the operation panel 121 of the image forming apparatus 100 when a replacement time of the storage 124, which is calculated based on the life prediction data acquired by the life prediction unit 14, is approaching.

When the image forming apparatus 100 includes an SSD as the storage 124, the life-related S.M.A.R.T. information acquisition unit 11 acquires the write count of the storage 124 from among the S.M.A.R.T. information, as S.M.A.R.T. information related to the life of the image forming apparatus 100. The life prediction unit 14 inputs a write count acquired from the S.M.A.R.T. information acquired periodically by the life-related S.M.A.R.T. information acquisition unit 11 and user information acquired periodically by the user information acquisition unit 12 to the trained model 13, thereby outputting life prediction data of the image forming apparatus 100.

Similarly, when the image forming apparatus 100 includes an HDD as the storage 124, the life-related S.M.A.R.T. information acquisition unit 11 acquires information related to the HDD including at least one of the power-on time, the operating time, the head load/unload cycle count, and the head retract time from among the S.M.A.R.T. information, as S.M.A.R.T. information related to the life of the image forming apparatus 100. The life prediction unit 14 inputs information related to the HDD, which is acquired from the S.M.A.R.T. information acquired periodically by the life-related S.M.A.R.T. information acquisition unit 11, and user information acquired periodically by the user information acquisition unit 12 to the trained model 13, thereby outputting life prediction data of the image forming apparatus 100.

The configuration described above allows the life of the storage 124 of the image forming apparatus 100 to be predicted by taking into account user information, which is information for determining the usage status of the image forming apparatus 100 by a user, in addition to the S.M.A.R.T. information, and by using different types of information to be acquired depending on the type of the storage 124. This allows a more accurate life prediction tailored to each user of the image forming apparatus 100 (information processing apparatus).

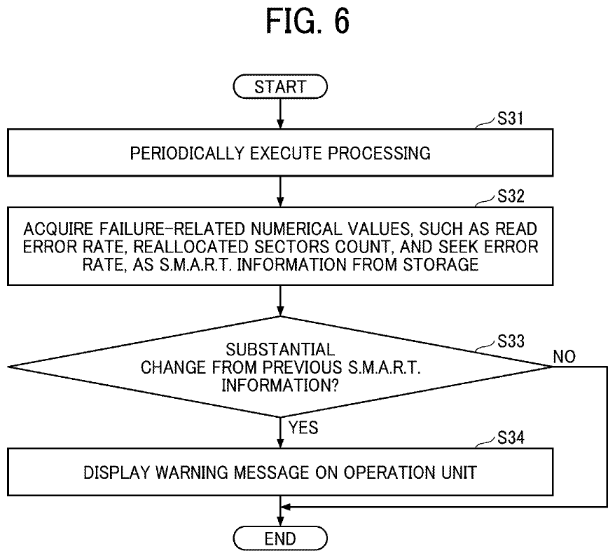

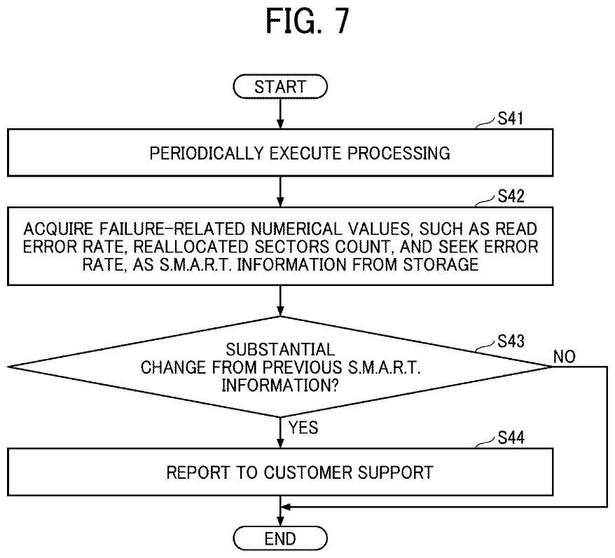

A failure notification function of the image forming apparatus 100 is described below with reference to FIG. 6 and FIG. 7.

FIG. 6 is a flowchart illustrating a first example of failure notification control of the image forming apparatus 100.

In step S31, control is performed such that the subsequent processing is executed periodically. As described above, “periodically” is preferably once per day, for example, and it is preferable to further reduce the frequency as the remaining life becomes shorter.

In step S32, the failure-related S.M.A.R.T. information acquisition unit 16 acquires, from the storage 124, numerical values related to a failure of the image forming apparatus 100, such as the read error rate, the reallocated sectors count, and the seek error rate, as failure-related S.M.A.R.T. information.

In step S33, the notification unit 17 determines whether the failure-related S.M.A.R.T. information acquired in step S32 has changed substantially from previous S.M.A.R.T. information. The previous S.M.A.R.T. information is, for example, failure-related S.M.A.R.T. information obtained in a control flow performed a predetermined number of times prior to the current control flow. For example, the notification unit 17 holds, for example, in a local memory, threshold information defining a predetermined threshold for a deviation of each failure-related S.M.A.R.T. information item, and determines that the failure-related S.M.A.R.T. information has changed substantially when a deviation between each failure-related S.M.A.R.T. information item and a corresponding previous S.M.A.R.T. information item is greater than or equal to the threshold.

If it is determined in step S33 that the failure-related S.M.A.R.T. information has changed substantially (Yes in step S33), the process proceeds to step S34, and a warning message indicating the occurrence of a failure is displayed on the operation unit of the image forming apparatus 100 (e.g., the operation panel 121 illustrated in FIG. 1). When the processing of step S34 is completed, the control flow ends.

On the other hand, if it is determined in step S33 that the failure-related S.M.A.R.T. information has not changed substantially (No in step S33), the control flow ends without performing the processing of step S34.

As described with reference to FIG. 6, the notification unit 17 can perform control to issue a warning message on the operation panel 121 of the image forming apparatus 100 when failure-related information recorded in the S.M.A.R.T. information changes at a frequency exceeding a predetermined value. This allows the occurrence of a failure to be promptly notified to a user or an administrator of the image forming apparatus 100, resulting in prompt recovery. The predetermined value is, for example, a value set in advance by an administrator.

FIG. 7 is a flowchart illustrating a second example of failure notification control of the image forming apparatus 100.

In step S41, control is performed such that the subsequent processing is executed periodically. As described above, “periodically” is preferably once per day, for example, and it is preferable to further reduce the frequency as the remaining life becomes shorter. For example, the frequency may be reduced when it is determined that the remaining life is shorter than a preset value.

In step S42, the failure-related S.M.A.R.T. information acquisition unit 16 acquires, from the storage 124, numerical values related to a failure of the image forming apparatus 100, such as the read error rate, the reallocated sectors count, and the seek error rate, as failure-related S.M.A.R.T. information.

In step S43, the notification unit 17 determines whether the failure-related S.M.A.R.T. information acquired in step S42 has changed substantially from previous S.M.A.R.T. information. The previous S.M.A.R.T. information is, for example, failure-related S.M.A.R.T. information obtained in a control flow performed a predetermined number of times prior to the current control flow. For example, the notification unit 17 holds, for example, in a local memory, threshold information defining a predetermined threshold for a deviation of each failure-related S.M.A.R.T. information item, and determines that the failure-related S.M.A.R.T. information has changed substantially when a deviation between each failure-related S.M.A.R.T. information item and a corresponding previous S.M.A.R.T. information item is greater than or equal to the threshold.

If it is determined in step S43 that the failure-related S.M.A.R.T. information has changed substantially (Yes in step S43), the process proceeds to step S44, and the occurrence of a failure is notified to the customer support of the image forming apparatus 100. When the processing of step S44 is completed, the control flow ends.

On the other hand, if it is determined in step S43 that the failure-related S.M.A.R.T. information has not changed substantially (No in step S43), the control flow ends without performing the processing of step S44.

As described with reference to FIG. 7, the notification unit 17 can perform control to notify the customer support of the image forming apparatus 100 when failure-related information recorded in the S.M.A.R.T. information changes at a frequency exceeding a predetermined value. This allows the occurrence of a failure to be promptly notified to the customer support of the image forming apparatus 100, resulting in prompt recovery.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising:
storage; and
circuitry configured to:
periodically acquire information related to the storage from management information;
periodically acquire user information stored in the storage; and
input the information related to the storage and the user information to a trained model and output life prediction data of the information processing apparatus, the trained model being a model to predict a life of the information processing apparatus based on the management information and the user information.

2. The information processing apparatus according to claim 1, wherein the information related to the storage includes a write count of the storage.

3. The information processing apparatus according to claim 2, wherein the storage includes a solid-state drive.

4. The information processing apparatus according to claim 1, wherein
the information related to the storage includes at least one of a power-on time, an operating time, a head load/unload cycle count, or a head retract time.

5. The information processing apparatus according to claim 4, wherein the storage includes a hard disk drive.

6. The information processing apparatus according to claim 1, wherein
the circuitry is configured to:
determine a weight for each function that uses the storage among the user information, based on an application type per job; and
cause the trained model to utilize data associated with functions as training datasets such that a higher weight is assigned to a training dataset for a function having a larger amount of access to the storage.

7. The information processing apparatus according to claim 1, wherein
the circuitry is configured to:
perform, at a frequency of at most once per day, acquisition of data or training of the trained model using the data, the data including the information related to the storage and the user information; and
reduce a frequency of the acquisition of the data or the training of the trained model when the information processing apparatus has a short remaining life.

8. The information processing apparatus according to claim 1, wherein
the management information includes failure-related information, and
the circuitry is configured to output a warning message when a frequency at which the failure-related information changes exceeds a predetermined value.

9. The information processing apparatus according to claim 1, wherein
the management information includes failure-related information, and
the circuitry is configured to report to customer support of the information processing apparatus when a frequency at which the failure-related information changes exceeds a predetermined value.

10. A life prediction method for an information processing apparatus, the life prediction method comprising:
periodically acquiring information related to storage included in the information processing apparatus from management information;
periodically acquiring user information stored in the storage; and
inputting the information related to the storage and the user information to a trained model and outputting life prediction data of the information processing apparatus, the trained model being a model to predict a life of the information processing apparatus based on the management information and the user information.

11. The life prediction method according to claim 10, further comprising:
determining a weight for each function that uses the storage among the user information, based on an application type per job; and
causing the trained model to utilize data associated with functions as training datasets such that a higher weight is assigned to a training dataset for a function having a larger amount of access to the storage.

12. The life prediction method according to claim 10, further comprising:
performing, at a frequency of at most once per day, acquisition of data or training of the trained model using the data, the data including the information related to the storage and the user information; and
reducing a frequency of the acquisition of the data or the training of the trained model when the information processing apparatus has a short remaining life.

13. The life prediction method according to claim 10, further comprising:
outputting a warning message when a frequency at which failure-related information changes exceeds a predetermined value, the failure-related information being included in the management information.

14. A non-transitory recording medium storing a plurality of instructions which, when executed by one or more processors, causes the one or more processors on an information processing apparatus to perform a life prediction method comprising:
periodically acquiring information related to storage included in the information processing apparatus from management information;
periodically acquiring user information stored in the storage; and
inputting the information related to the storage and the user information to a trained model and outputting life prediction data of the information processing apparatus, the trained model being a model to predict a life of the information processing apparatus based on the management information and the user information.
